(19) United States
(12) Patent Application Publication
(10) Pub. No.: US 2010/0190665 A1
(43) Pub. Date: Jul. 29, 2010

(54) FLUID AND METHOD FOR AGGLOMERATING PARTICLES IN A WELL SERVICE OPERATION

(76) Inventors: Kewei Zhang, Calgary (CA); Darren K. Lee, Langdon (CA)

Correspondence Address: SMITH FROHWEIN TEMPEL GREENLEE BLAHA, LLC, Two Ravinia Drive, Suite 700, ATLANTA, GA, 30346, US

(21) Appl. No.: 12/394,921

(22) Filed: Feb. 27, 2009

(30) Foreign Application Priority Data
Feb. 28, 2008 (CA) CA-2,267,102

(51) Int. Cl. C09K 8/588; C09K 8/68

(52) U.S. Cl. 507/225; 507/203

(57) ABSTRACT

Flocculants and/or coagulants are used with recyclable drilling fluids to agglomerate particles and in particular fine solids (“fines”) including coal fines, such that they settle out of the fluid. The most widely used flocculants are different types of polymers including polyacrylamide (PMA) having different molecular weights, polyethylene oxide (PEO) having various molecular weights and other suitable polymeric flocculents known in coal beneficiation industry. For coal fines, other coagulants such as hydrocarbons, including kerosene, fuel oil, or a C₅ to C₈ hydrocarbon, either alone or in combination with a surfactant or a polymer, can also be used.

### CROSS-REFERENCE TO RELATED APPLICATIONS

This application is a United States Non-provisional Application for Patent being filed under 37 CFR 1.53(b) and claiming the foreign priority benefits under 35 U.S.C. 119(a) of Canadian Application for Patent filed on Feb. 28, 2008 and assigned serial number CA-2,627,102, which application is incorporated herein by reference.

### BACKGROUND

### Field

This disclosure relates to a fluid and method for agglomerating particles in a well service operation in general and in well services for coal seams in particular.

Subterranean coal seams contain enormous amounts of natural gas, primarily in the form of methane. Coal seams contain a network of cleats that typically contain water. The bulk of gas is adsorbed onto the coal matrix. The recovery of methane gas from the formation generally involves drilling the well, hydraulic fracturing the formation and producing formation water (dewatering) from the coal seams thereby reducing the formation pressure. Upon reduction of formation pressure, methane gas desorbs and flows through the cleat network to the wellbore.

The recovery of methane gas from coal seams is different from the recovery of gas from conventional formations such as sandstone or limestone formations. The lithology and mineralogy of the coal are substantially different. Gas in coal seams is adsorbed on the coal matrix, while gas occupies the interstices of the sandstone or limestone formations. Generally, after the formation pressure is reduced to a certain level, gas starts to desorb and seeps through the cleat networks to the created fractures and then flows to the wellbore. The permeability of the coal seam is determined to a great extent by the cleat network. Compared to conventional sandstone or limestone, coal is much more soft and brittle. Thereby, during various operations including drilling and hydraulic fracturing, substantial amounts of coal fines are generated. Coupled with generally low formation pressure, coal fines can readily penetrate into cleats causing significant formation damage.

It is common to use water or brine including formation water as a drilling fluid for drilling wells in coal seams. During the drilling operation, large amounts of coal particles, ranging from fines to pebbles, are generated. Drilling fluid, such as water or brine, is circulated through the wellbore and transports the particles out of the wellbore. After going through filtration on the surface, the water or brine is often reused as drilling fluid. As many coal fines are too small to be filtered out, substantial amounts of fines are re-injected into the well. These re-injected fines can cause significant formation damage.

### BRIEF SUMMARY

The present disclosure, in one aspect, relates to a method for a well service operation using a fluid comprising of a flocculent and an aqueous liquid.

The present disclosure, in another aspect, relates to a method for a well service operation using a fluid comprising of a coagulant and an aqueous liquid.

The present disclosure, in a further aspect, relates to a method for agglomerating particles in a well service operation using a fluid comprising a flocculent and an aqueous liquid.

### DETAILED DESCRIPTION OF VARIOUS EMBODIMENTS

Flocculation and coagulation has been widely used in many industries including coal beneficiation. In the fluids and method of the present disclosure, flocculants and/or coagulants are used to agglomerate particles and in particular fine solids (“fines”) including coal fines, such that they settle out of the fluid. The most widely used flocculants are different types of polymers including polyacrylamide (PMA) having different molecular weights, polyethylene oxide (PEO) having various molecular weights and other suitable polymeric flocculents known in coal beneficiation industry. For coal fines, other coagulants such as hydrocarbons, including kerosene, fuel oil, or a C₅ to C₈ hydrocarbon, either alone or in combination with a surfactant or a polymer, can also be used.

When drilling a well in a coal seam using water or a brine as the drilling fluid, small quantities of a polymeric flocculent, for example PMA, can be added to the drilling fluid. The coal fines generated during drilling are agglomerated quickly by the flocculent. Once the fluid is circulated back to the surface, the agglomerated fines are separated from the fluid either by filtration or quick settlementation. The filtered fluid, which contains much fewer fines, can be reused. Alternatively, a polymeric flocculent can be added to the drilling fluid after it has been circulated back from the well.

Similarly a small amount of the flocculent can also be added to water containing coal fines to make the fines settle out. The resulting water which contains less coal can be disposed, or injected into an injection well.

In addition to drilling operations, the fluids and methods presented in the present disclosure can also be applied in other well service operations in coal seams including wellbore cleanout and hydraulic fracturing operations, where aqueous fluids are used.

The amount and type of the flocculent required generally depends on the type of coal, the amount of coal fines in the fluids and the water quality including salinity and pH. Preferably, the amount of flocculent required is very limited and more preferably in the range of 1-100 ppm of the well service fluid. In addition to the flocculent, other additives such as surfactants, and clay stabilizers can also be added into the service fluids. Other coagulants for coal fines such as hydrocarbon, including kerosene, fuel oil, or a C₅ to C₈ hydrocarbon, can also be used in combination with the flocculent.

It has been observed by the inventor that flocculents according to the present disclosure cause not only coal fines but also silica as well as carbonate fines that are present in the fluid to coagulate and form flocs. In field operations, these fines often intermingle with each other.

### EXAMPLE

10 grams of grounded Manville coal and 100 ml of formation water were added into each of two glass bottles (200ml). 0.05 ml of PMA water solution was added into one of the bottles and the sample in the other bottle was used as control. The concentration of PMA in the water solution is 1.5 wt %. The bottles were shaken and then let stand to allow coal particles settle. In the bottle containing the flocculent, coal fines formed flocs and settled and the supernatant became relatively clear within about 30 seconds.

In the control sample there was no immediate settling of coal fines and the fluid still appeared black after 30 minutes.

What is claimed is:

1. A method for a well service operation using a fluid comprising of a flocculent and an aqueous liquid.

2. The method according to claim 1, wherein the fluid is a drilling fluid, fracturing fluid or well clean-out fluid.

3. The method according to claim 1, wherein the fluid further includes a coagulant.

4. The method according to claim 3, wherein the coagulant is a hydrocarbon.

5. The method according to claim 4, wherein the hydrocarbon is kerosene, fuel oil, or a C₅, C₆, C₇ or C₈ hydrocarbon.

6. The method according to claim 1, wherein the flocculent is a polmeric flocculent.

7. The method according to claim 1, wherein the flocculent is PMA.

8. The method according to claim 1, wherein the flocculent is PEO.

9. The method according to claim 7, wherein the PMA is in a concentration in the range of about 1 ppm to about 100 ppm.

10. The method according to claim 1, wherein the well service operation is a drilling operation, a wellbore clean-out operation or a hydraulic fracturing operation.

11. The method according to claim 1, wherein the well service operation is carried out in a coal seam.

12. A method for a well service operation using a fluid comprising of a coagulant and an aqueous liquid.

13. The method according to claim 12, wherein the coagulant is hydrocarbon.

14. The method according to claim 13, wherein the hydrocarbon is kerosene, fuel oil, or a C₅, C₆, C₇ or C₈ hydrocarbon.

15. The method according to claim 12, wherein the well service operation is a drilling operation, a wellbore clean-out operation or a hydraulic fracturing operation.

16. The method according to claim 12, wherein the well service operation is carried out in a coal seam.

17. A method for agglomerating particles in a well service operation using a fluid comprising a flocculent and an aqueous liquid.

18. The method according to claim 17, wherein the particles are fines from a coal seam.

19. The method according to claim 17, wherein the fluid is a drilling fluid, fracturing fluid or well clean-out fluid.

20. The method according to claim 17, wherein the fluid further includes a coagulant.

21. The method according to claim 17, wherein the flocculent is a polymer.

22. The method according to claim 17, wherein the flocculent is PMA or PEO.

23. The method according to claim 20, wherein the coagulant is a hydrocarbon.

24. The method according to claim 23, wherein the hydrocarbon is kerosene, fuel oil, or a C₅, C₆, C₇ or C₈ hydrocarbon.

25. The method according to claim 1, wherein the flocculant is added to the fluid before, during or after drilling.

26. The method according to claim 1, wherein the flocculant is added to water containing coal fines for settling out the coal fines whereby the resulting water can be separated.

27. The method according to claim 1, wherein the fluid further comprises surfactants.

28. The method according to claim 1, wherein the fluid further comprises clay stabilizers.
